(19) United States
(12) Patent Application Publication
(10) Pub. No.: US 2009/0217995 A1
(43) Pub. Date: Sep. 3, 2009

(54) Rotary slide valve, in particular for hydraulic power assisted steering systems in motor vehicles

(76) Inventor: Markus Lingemann, Bochum (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/919,813

(22) PCT Filed: May 3, 2006
(86) PCT No.: PCT/EP2006/004130

§ 371 Date: Jan. 7, 2009

(30) Foreign Application Priority Data
May 3, 2005 (DE) 20 2005 007 092.0

(51) Int. Cl. B62D 5/083

(52) U.S. Cl. 137/625.21

(57) ABSTRACT

A rotary slide valve, in particular for hydraulic power-assisted steering systems in motor vehicles, having a control bush and a rotary slide which is adapted to rotate within the control bush about a common longitudinal axis, the rotary slide and the control bush including a plurality of control edges, of which one control edge each of the control bush forms control gaps with a nearest control edge of the rotary slide, and adjacent control gaps of supply ports for a hydraulic fluid determining a control geometry, is characterized in that the rotary slide valve has at least two different control geometries.

### CROSS-REFERENCE TO RELATED APPLICATIONS

This application is a national stage of International Application No. PCT/EP2006/004130 filed May 3, 2006, the disclosures of which are incorporated herein by reference in entirety, and which claimed priority to German Patent Application No. 20 2005 007 092.0 filed May 3, 2005, the disclosures of which are incorporated herein by reference in entirety.

### BACKGROUND OF THE INVENTION

The invention relates to a rotary slide valve, in particular for hydraulic power-assisted steering systems in motor vehicles.

Rotary slide valves are generally known and are for example installed by the motorcar industry in hydraulic power-assisted steering systems. As a rule, such steering systems include a working cylinder which is divided by a piston into two working spaces. The rotary slide valve is connected to both working spaces and controls the pressure therein by means of a hydraulic fluid. By manually turning the steering wheel the rotary slide valve is actuated and provides for a difference in pressure Δp in the working spaces of the working cylinder. Finally, the resulting pressure on the pistons generates a hydraulic assisting force which acts in addition to the mechanically transmitted steering force when the steering wheel is turned.

In principle, it is desirable that the characteristic of a power-assisted steering can be adapted to predefined parameters. One possibility of this adaptation is disclosed in EP 0 773 156 B1, and corresponding U.S. Pat. No. 6,000,431, both of which are incorporated by reference herein in entirety. This document describes a rotary slide valve which defines different characteristic curves of the rotary slide valve by axially displacing the rotary slide relative to the control bush. EP 1 131 239 B1, and corresponding U.S. Pat. No. 6,397,889, both of which are incorporated by reference herein in entirety, describes a method for assembling such a rotary slide valve. In order to obtain a desired characteristic curve with these rotary slide valves, first of all the rotary slide has to be oriented in a hydraulic center position by being rotated about the common longitudinal axis and clamped so as to prevent relative rotation. Thereafter, it is further adjusted in the axial direction.

### BRIEF SUMMARY OF THE INVENTION

It is a feature of the present invention to provide a more advantageous design for the rotary slide valve, the possibility to generate different characteristic curves with a rotary slide valve being maintained.

In accordance with the invention this feature is achieved by a rotary slide valve of the aforementioned kind which is characterized in that the rotary slide valve has at least two different control geometries. An advantage of such a rotary slide valve is that by means of different control geometries in the circumferential direction an adjustment during assembly of the rotary slide valve solely by a rotation of the rotary slide relative to the control bush is possible. Thus, when adjusting a desired characteristic curve of the rotary slide valve no axial displacement of the rotary slide relative to the control bush is necessary. The rotary slide has only to be oriented in its hydraulic center position by a slight rotation about its so-called assembly position after being placed in the control bush.

In one embodiment the rotary slide defines new control geometries by means of different assembly positions which solely differ in a predetermined angle of rotation of the rotary slide relative to the control bush, a typical characteristic curve of the rotary slide valve being associated with each assembly position of the rotary slide. In a particularly preferred embodiment these typical characteristic curves are different in each assembly position of the rotary slide. In case the tolerance on a desired characteristic curve of the rotary slide valve is intended to be reduced, this embodiment offers a group of characteristic curves from which the best fitting characteristic curve may be selected.

The assembly positions may differ in the height of the control gaps, in other embodiments in the length of the control gaps. With respect to a minimum possible expenditure in manufacturing design variants have proven to be particularly advantageous in which in the various assembly positions both the height and the length of the control gaps differ from each other.

Other advantages of this invention will become apparent to those skilled in the art from the following detailed description of the preferred embodiments, which read in light of the accompanying drawings.

### BRIEF DESCRIPTION OF THE DRAWINGS

FIGS. 1a to 1d show a functional principle with the aid of four cross sections of a first embodiment of the rotary slide valve in accordance with the invention;

FIG. 2 shows a diagram in which a flow cross section is plotted against an angle of rotation for the rotary slide valve according to FIG. 1;

FIG. 3 shows a diagram including characteristic curves of the rotary slide valve according to FIG. 1;

FIG. 4 shows the functional principle of a second embodiment of the rotary slide valve in accordance with the invention;

FIG. 5 shows a development of the control bush and of the rotary slide of the rotary slide valve according to FIG. 4;

FIG. 6 shows an example of possible control geometries of the second embodiment of the rotary slide valve in accordance with the invention;

FIG. 7 shows a diagram in which the flow cross section is plotted against the angle of rotation for the rotary slide valve according to FIG. 6;

FIG. 8 shows a diagram including characteristic curves of the rotary slide valve according to FIG. 6;

FIG. 9 shows a rotary slide and a control bush according to a third embodiment of the rotary slide valve in accordance with the invention;

FIG. 10 shows an example of possible control geometries of the third embodiment of the rotary slide valve in accordance with the invention;

FIG. 11 shows a diagram including characteristic curves of the rotary slide valve according to FIG. 10; and

FIG. 12 shows a diagram including statistical moment distribution curves of a rotary slide valve with a fixed pressure value.

### DETAILED DESCRIPTION OF THE INVENTION

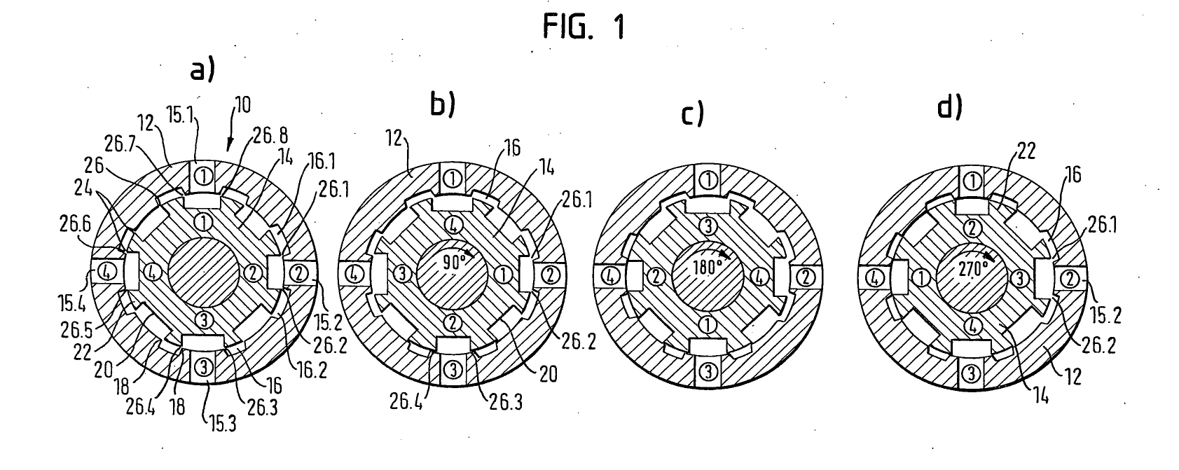

FIGS. 1a to 1d show four cross sections of a rotary slide valve 10, including a control bush 12 and a rotary slide 14. The numerals 1 to 4 on the control bush 12 designate supply ports 15 for a hydraulic fluid. The control bush 12 has the shape of a hollow cylinder having a longitudinal axis, the inner side of the control bush 12 comprising a plurality of axial control grooves 16. Each control groove 16.1 to 16.8 defines two control edges 18 on the control bush 12. The rotary slide 14 is rotatably guided in the control bush 12 and has the shape of a cylinder. It comprises at its outside control grooves 20 and remaining lands 22. The control grooves 20 also define two control edges 24 each on the rotary slide 14.

In a first assembly position (FIG. 1a) the lands 22 of the rotary slide 14 substantially extend across the control grooves 16 of the control bush 12. The respectively nearest control edges of the control bush 12 and of the rotary slide 14 form control gaps 26. Thus, the adjacent control grooves 16.1 and 16.2 of the supply port 15.2 define, for example, together with the adjacent lands 22 of the rotary slide 14 the control gaps 26.1 and 26.2. Analogously, the adjacent control gaps of the supply port 15.3 are designated with 26.3 and 26.4, the adjacent control gaps of the supply port 15.4 are designated with 26.5 and 26.6, and the adjacent control gaps of the supply port 15.1 are designated with 26.7 and 26.8. A height of the control gaps is defined as the smallest possible distance of two gap-forming control edges 18, 24. The control gaps 26.1 and 26.2 have identical dimensions in a hydraulic center position, because they are the two adjacent control gaps of the supply port 15.2. The control gaps 26.1 and 26.2 define a control geometry, just like the adjacent control gaps of the further supply ports 15.1, 15.3, and 15.4. The control geometry is defined by the axial length and the height of the two control gaps and by their axial position and distance with respect to one another in the circumferential direction. In the first assembly position (FIG. 1a), the length, the height, and the axial position of the control gaps 26 with respect to each other are largely identical.

FIG. 1b shows a second assembly position in which the rotary slide 14 was rotated clockwise through 90° as compared to FIG. 1a. The numerals 1 to 4 on the rotary slide 14 show this clearly. A comparison of the control gaps 26.3/26.4 with, for example, the control gaps 26.1/26.2 already shows in this assembly position different heights of the control gaps. This is attained by the different control geometries, hence in the first embodiment this is substantially attained as a result of the different dimensions of the control grooves 16, 20 in the circumferential direction.

According to FIG. 1c, a third assembly position with different widths of the control gaps is achieved by further rotating the rotary slide 14 clockwise through 90°.

In FIG. 1d, the rotary slide 14 was again rotated clockwise through another 90°, whereby a fourth assembly position is created. In this assembly position the narrowest lands 22 of the rotary slide 14, as seen in the circumferential direction, adjoin in the vicinity of the supply port 15.2 the widest control grooves 16 of the control bush 12, as seen in the circumferential direction. In this way, the widest control gaps 26.1 and 26.2 of the first embodiment materialize.

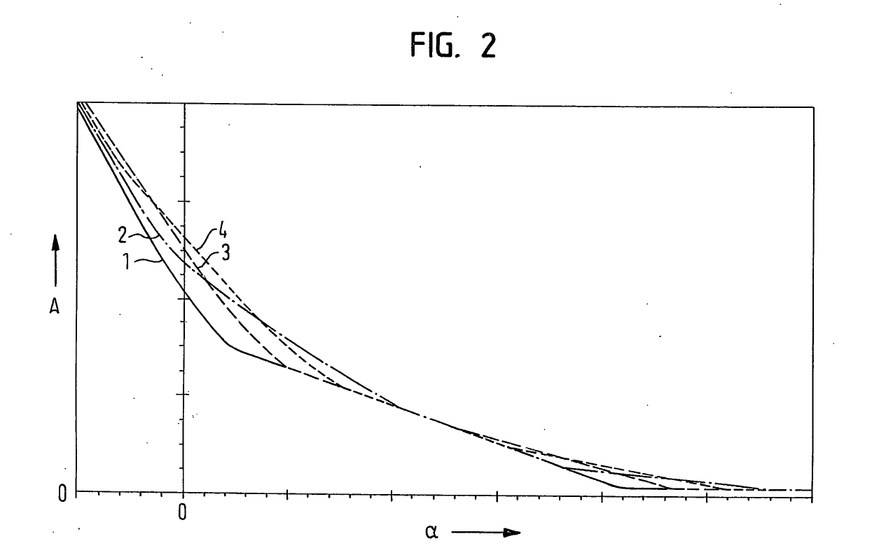

The control gaps 26 determine in every assembly position a flow cross section A for the hydraulic fluid and, consequently, a flow resistance. In this arrangement the sum of the flows through the control gaps 26.1, 26.3, 26.5, and 26.7 result in a first flow cross section, the sum of the flows through the control gaps 26.2, 26.4, 26.6, and 26.8 result in a second flow cross section towards the working spaces of the working cylinder. In the hydraulic center position both flow cross sections are equal. Depending on the direction in which the steering wheel is turned, one flow cross section decreases whilst the other one increases, and vice versa. In FIG. 2, the first flow cross section is represented against an angle of rotation α of the rotary slide 14 with respect the control bush 12 owing to the steering wheel being turned, the angle of rotation α being in the range of approx. 3°. The curve of the second flow cross section would correspond to a reflection of the first flow cross section at the axis of the ordinate. The numerals at the curves correspond to the assembly positions in FIG. 1. In the hydraulic center position, i.e. at zero on the abscissa, the flow cross section A continuously increases from the assembly position 1 to 4 analogous to the maximum gap width. The diagram of FIG. 2 further shows that the curves belonging to the assembly positions having larger gap widths come closer to the minimum of the flow level only at a larger angle of rotation α. Since the rotary slide 14 must be rotatable in the control bush 12 without any major resistance, the rotary slide valve 10 is never entirely tight, even if the lands of the rotary slide 14 and of the control bush 12 are adjacent to each other. Therefore, the flow cross section never reaches zero, but merely a minimum near zero.

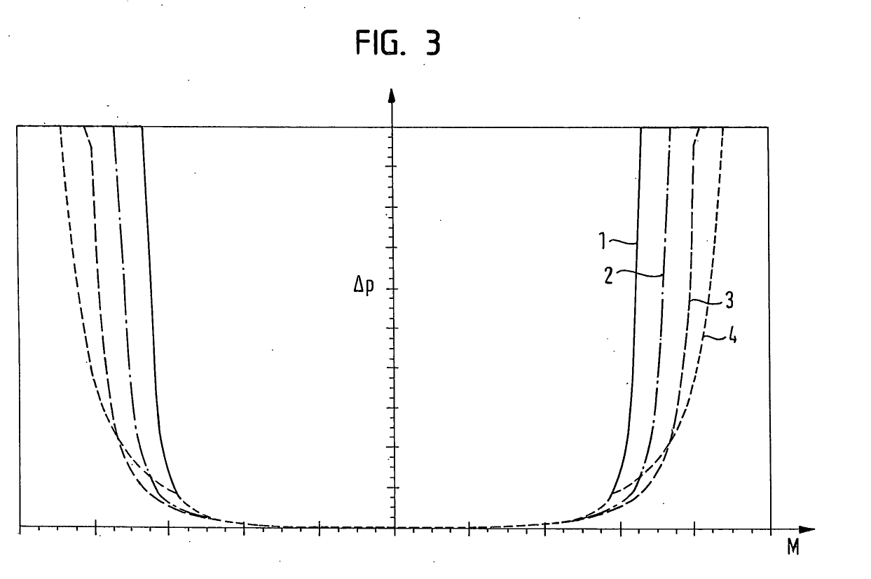

FIG. 3 shows an accompanying diagram in which a difference in pressure Δp of the working spaces of the working cylinder is plotted against a steering moment M. Drawn into the diagram are characteristic curves of the rotary slide valve of FIG. 1, the characteristic curves being numbered according to the assembly positions 1 to 4. The characteristic curve 4 thus corresponds to the fourth assembly position in FIG. 1d with the maximum width of the control gaps 26.1 and 26.2. In order to achieve a high difference in pressure in the working spaces of the working cylinder, one of the flow cross sections towards the working spaces has to reach its minimum. This occurs in the fourth assembly position only at a relatively large angle of rotation α (cf. FIG. 2). For a large angle of rotation α a correspondingly large steering moment M has to be applied. Therefore, in FIG. 3 the difference in pressure Δp rapidly increases only with relatively large steering moments M. In accordance with this principle, each assembly position determines a different characteristic curve according to FIG. 3.

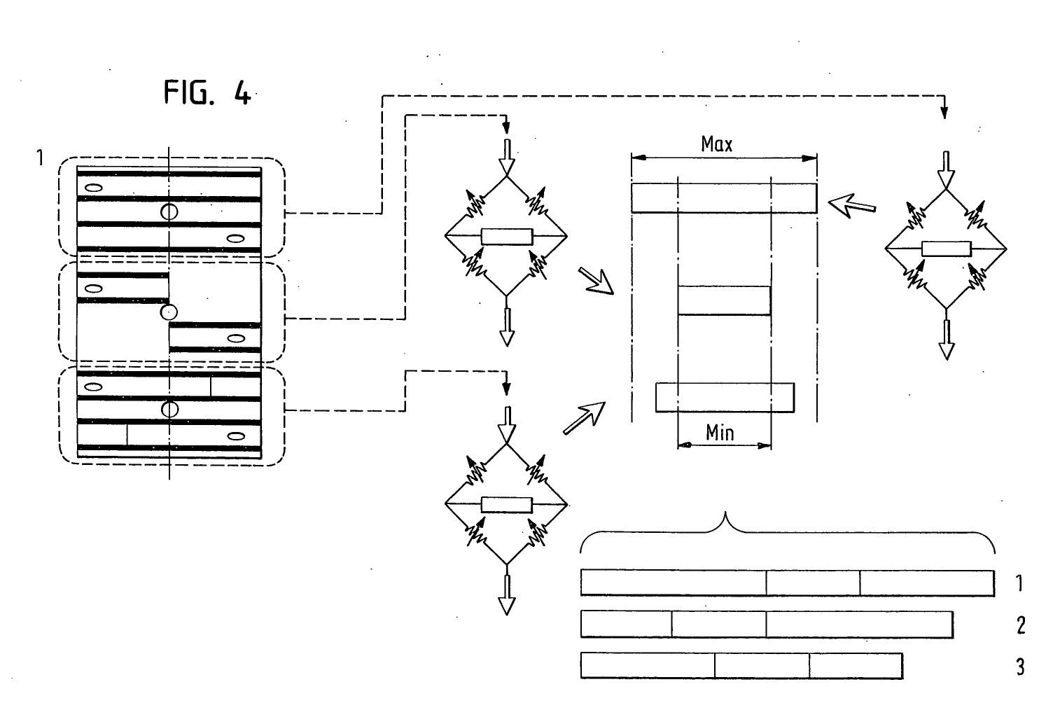

FIG. 4 shows the functional principle of a second embodiment of the rotary slide valve 10. On the left-hand side, three so-called hydraulic bridges (framed in broken lines) are shown in the first assembly position (designated by the numeral 1) of a rotary slide valve 10 including six control grooves 16, 20. Each hydraulic bridge is characterized by a typical control geometry, comprises a flow resistance represented symbolically, and determines a partial flow ranging between a minimum and a maximum (FIG. 4, at the top on the right). In a rotary slide valve including six control grooves 16, 20 three different assembly positions are achieved by rotating the rotary slide 14 through 120° each in the control bush 12 (“six land” valve). Owing to the combination of the different control geometries three different flow cross sections for a hydraulic fluid materialize. The flow cross sections are represented as bars in FIG. 4 at the bottom on the right and are numbered 1 to 3 corresponding to their assembly positions. The different flow cross sections then finally result in the different characteristic curves of the rotary slide valve 10.

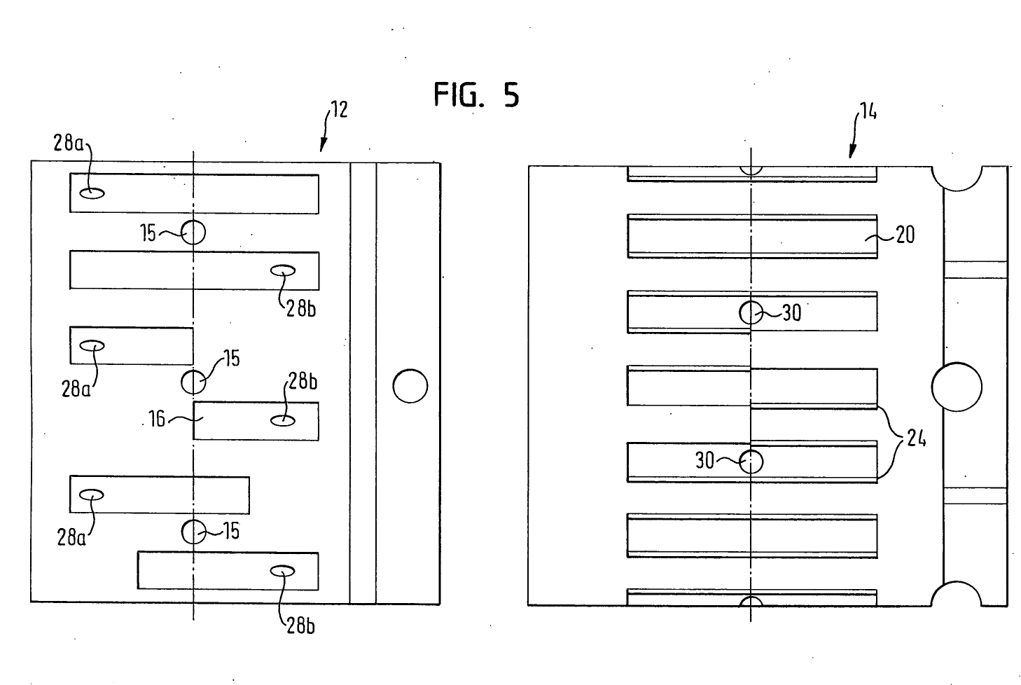

FIG. 5 shows a development of the control bush 12 and of the rotary slide 14 of the second embodiment of the rotary slide valve. On the left-hand side of FIG. 5, the control bush 12 can be seen including the supply ports 15 and the transmission openings 28a and 28b. The transmission openings 28a and 28b are connected to the working spaces of the working cylinder. Further apparent is that the control grooves 16 of the control bush 12 are equal in length in pairs and are axially offset with respect to one another. On the right-hand side of FIG. 5, the rotary slide 14 with its outlet ports 30 in every other control groove 20 of the rotary slide can be seen, the control edges 24 of the rotary slide 14 differing in their axial lengths. If the two developments were now placed on top of one another, the three control geometries in the first assembly position of FIG. 4 would be the result.

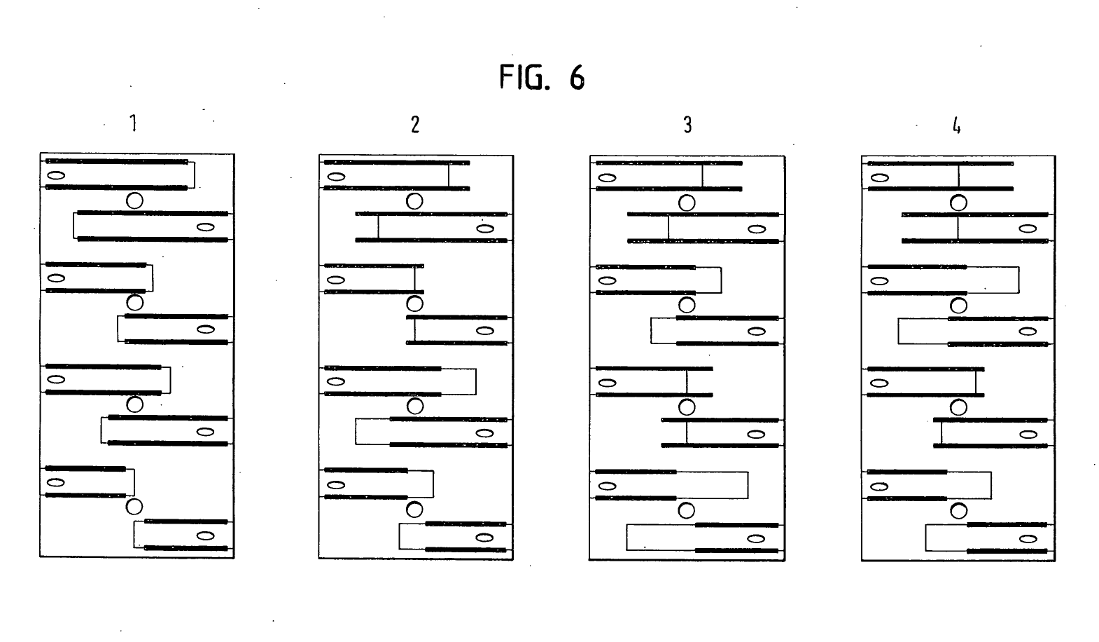

FIG. 6 shows an example of possible control geometries of the second embodiment of the rotary slide valve in the development. Represented is a rotary slide valve 10 comprising eight control grooves 16, 20, and, accordingly, the illustrated assembly positions 1 to 4 are possible. With such a rotary slide valve 10, the assembly positions 1 to 4 differ by the rotary slide 14 being rotated through 90° each relative to the control bush 12 (“eight land” valve). In contrast to the first embodiment the control geometries are largely identical in the circumferential direction; they differ here in the axial position and length of the control gaps 26. The control gap length is defined as the axial dimension through which both gap-forming control edges 18, 24 extend. If the control grooves 16, 20 and thus also the control edges 18, 24 are disposed axially offset, the control gap length is, accordingly, not identical to the control edge length. In accordance with the principle represented in FIG. 4, the control geometries and the assembly positions in FIG. 6 are selected such that the flow cross section A in the hydraulic center position constantly decreases from the left to the right.

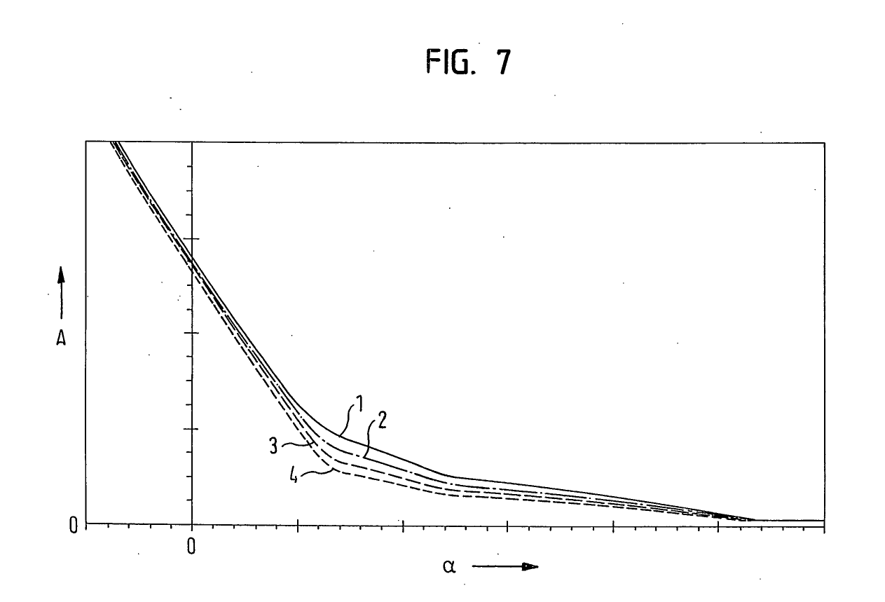

In the diagram of FIG. 7, the flow cross section A is plotted against the angle of rotation α. The curves drawn are designated according to the assembly positions of FIG. 6. The explanations with regard to the diagram correspond to a great extent to those referring to FIG. 2. The special feature should, however, be pointed out that all of the curves reach the minimum flow cross section almost at the same time. On account of the fact that the width of the control gaps 26 is constant in all assembly positions of the second embodiment, the minimum flow cross section A is always reached at the same angle of rotation α.

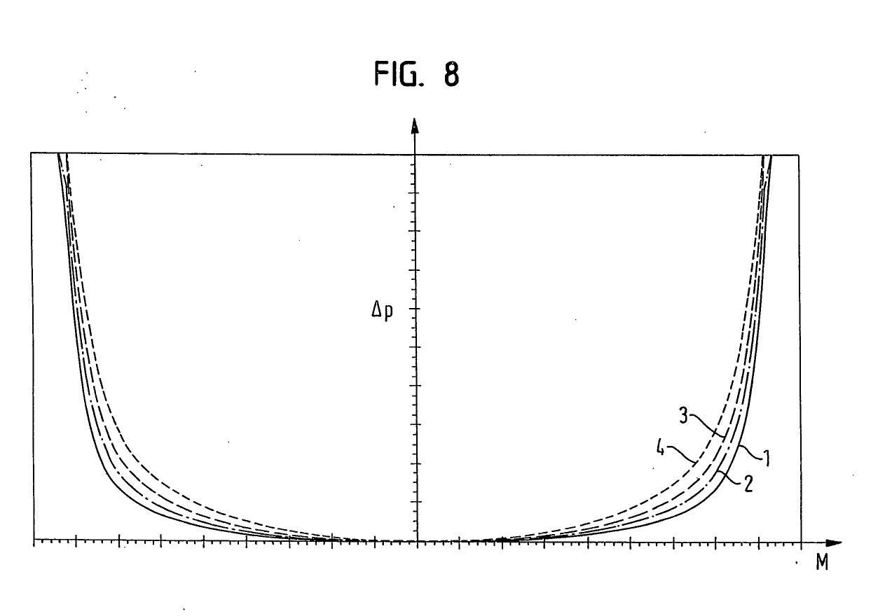

Analogous to the first embodiment in FIG. 3, FIG. 8 shows the characteristic curves of the second embodiment of the rotary slide valve 10 of FIG. 6, the difference in pressure Δp being again plotted against the steering moment M. The four characteristic curves drawn relate to the assembly positions 1 to 4 of FIG. 6. FIG. 8 clearly shows that also in the second embodiment different characteristic curves of the rotary slide valve 10 are attained because of different assembly positions.

In the embodiments described in particular the production of the rotary slide 14 is relatively complicated. Namely, in the first embodiment grooves having different dimensions in the circumferential direction have to be molded into the rotary slide 14 (and the control bush 12). In the second embodiment the production of the control edges 24 of different axial extents, in particular at the rotary slide 14, proves to be particularly difficult.

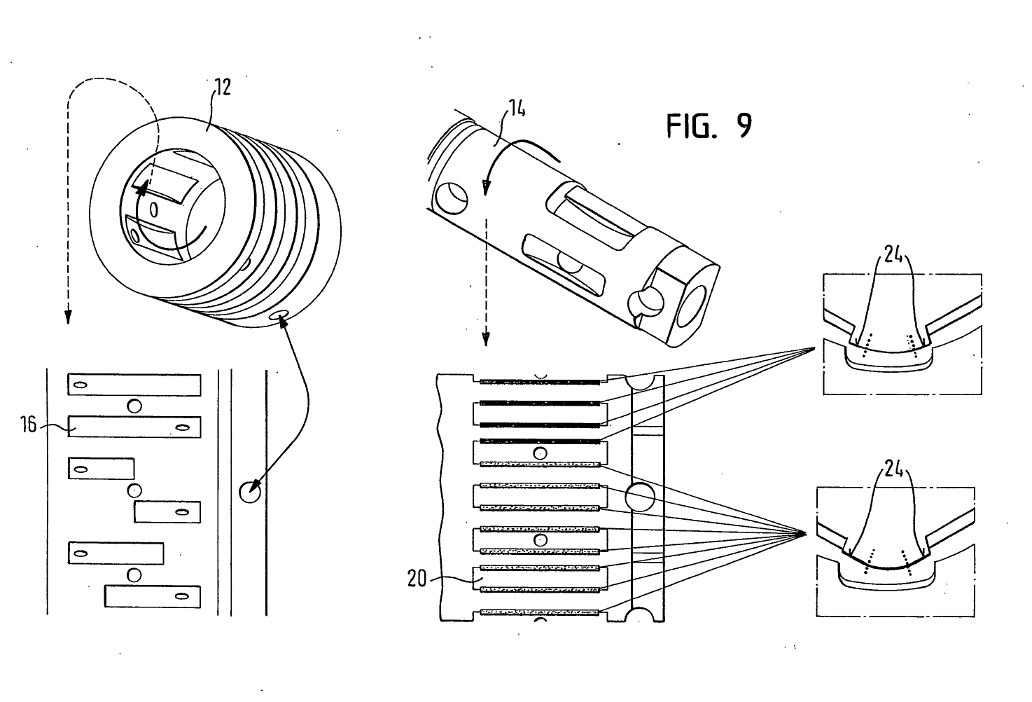

In a third embodiment according to FIGS. 9 to 12, this expenditure in manufacturing is considerably reduced by the control geometries differing in the gap length and the gap height of the control gaps 26.

FIG. 9 shows the control bush 12 and the rotary slide 14, and the developments thereof. In contrast to the first embodiment, the distance of the control edges 18 of the control bush 12 and, initially, also the distance of the control edges 24 of the rotary slide 14 in the circumferential direction are equal. The axial dimensions of the individual control grooves 20 of the rotary slide 14 is likewise identical, so that at first the rotary slide may be manufactured to be completely rotationally symmetrical. In order to attain a variation of the gap height, the control edges 24 of the rotary slide 14 are chamfered or beveled differently. The chamfers are schematically represented on the right-hand side of FIG. 9 as a simple planar polished section, it being possible in detail to configure different polished section contours (e.g. curved, polygonal, planar, etc., as seen in cross section) and different polished section angles towards a radial straight line. The points where each planar polished section continues into the curved circular contour of the rotary slide are emphasized here by dotted lines. In the present example, the upper four control edges 24 (represented in bold solid lines) are chamfered more slightly than the lower eight control edges 24 (represented dotted). In order to obtain a variation of the gap length, the control bush 12 is configured, just as in the second embodiment according to FIG. 5, with control grooves 16 being equal in length in pairs and being axially offset with respect to each other.

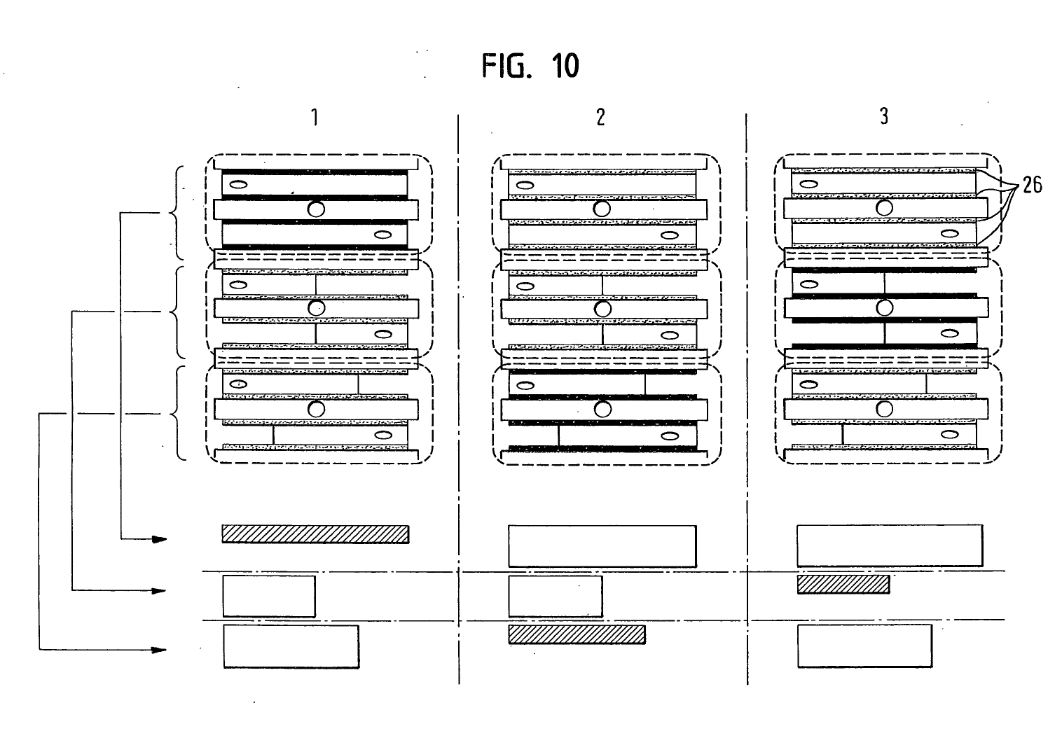

Three assembly positions are possible for the rotary slide valve 10 having six control grooves 16, 20 represented in FIG. 9 (“six land” valve). The assembly positions 1 to 3 are apparent in FIG. 10 and differ by the rotary slide 14 being rotated through 120° each relative to the control bush 12. Four control gaps 26 each form a hydraulic bridge (drawn in broken lines) and determine a partial flow (FIG. 10, at the bottom). The partial flow depends in this arrangement on the respective control gap height because of the chamfered control edges 24 and on the control gap length because of the control grooves 16 of the control bush 12 of different lengths. In the present example, the four slightly chamfered control edges 24 of the rotary slide 14 (represented in solid bold lines) cooperate in each assembly position with control edges 18 of the control bush 12 of different lengths, so that in each assembly position a different total flow is achieved.

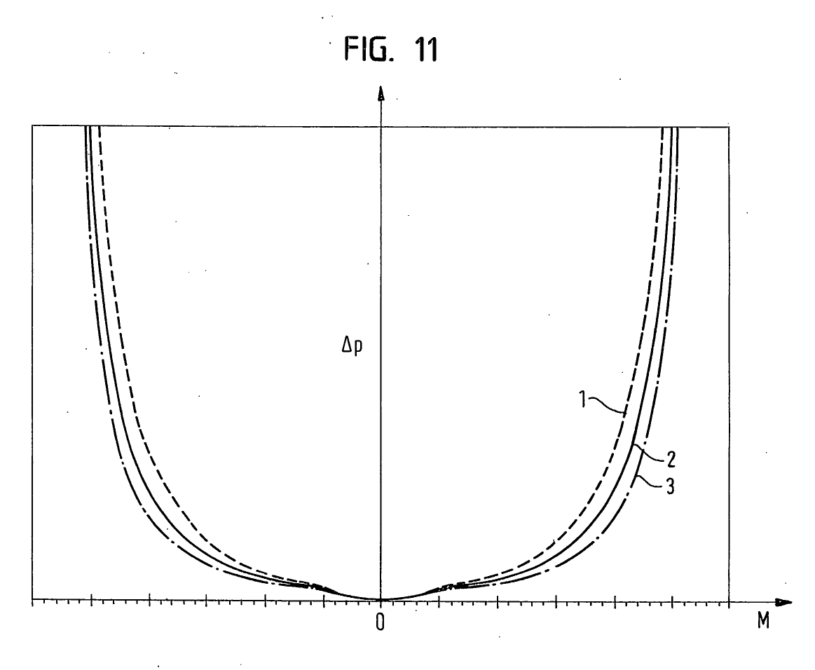

Analogous to FIGS. 3 and 8, FIG. 11 shows the characteristic curves of the third embodiment of the rotary slide valve 10 of FIG. 9, the difference in pressure Δp again being plotted against the steering moment M. The three characteristic curves drawn relate to the assembly positions 1 to 3 of FIG. 10. FIG. 11 clearly shows that also in the third embodiment different characteristic curves of the rotary slide valve 10 are attained because of different assembly positions.

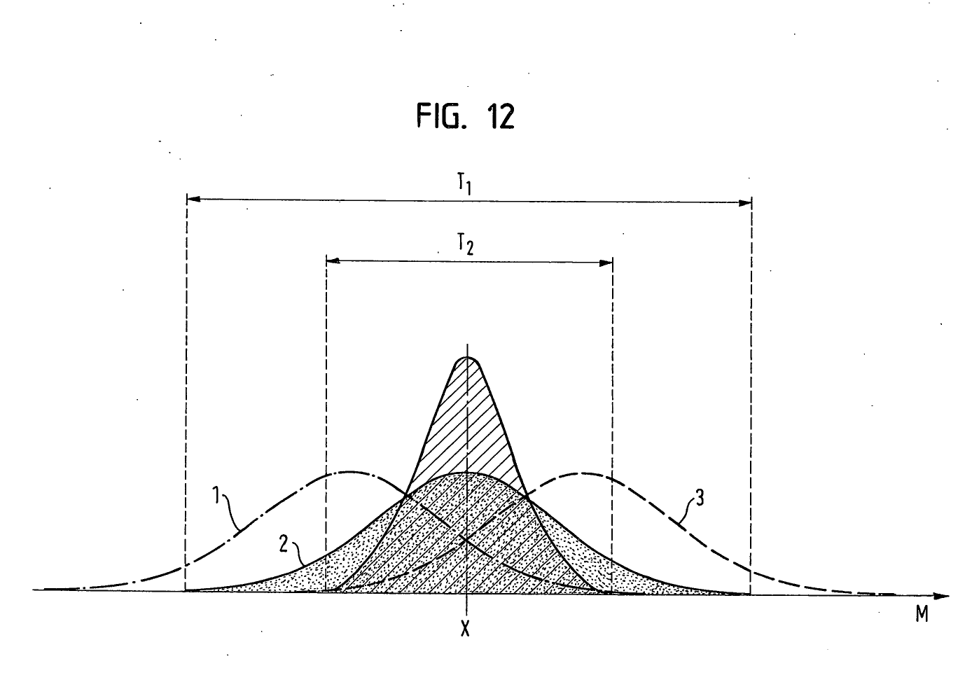

With these characteristic curves a statistical moment dispersion about a desired value X according to FIG. 12 is determined by manufacture with a fixed pressure value. The moment distribution curve of a rotary slide valve according to the current prior art is represented in FIG. 12 with a grey background and corresponds in the present example to the distribution curve of the rotary slide valve 10 in accordance with the invention in its second assembly position. Here, the deviation from the desired value is in a relatively large tolerance range T₁. The distribution curves 1 and 3 drawn in dashed and dash-dot lines, respectively, accordingly result from the first and third assembly positions of the rotary slide valve according to FIGS. 9 and 10. By selecting the “best assembly position” the distribution curves 1 to 3 superimpose to form the hatched distribution curve having a substantially smaller tolerance range T₂.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A rotary slide valve, in particular for hydraulic power-assisted steering systems in motor vehicles, comprising a control bush and a rotary slide which is adapted to rotate within the control bush about a common longitudinal axis, the rotary slide and the control bush including a plurality of control edges, of which one control edge each of the control bush forms control gaps with a nearest control edge of the rotary slide, and adjacent control gaps of supply ports for a hydraulic fluid determining a control geometry, wherein the rotary slide valve has at least two different control geometries.

2. The rotary slide valve according to claim 1, wherein the rotary slide defines new control geometries by different assembly positions which solely differ in a predetermined angle of rotation of the rotary slide relative to the control bush, a typical characteristic curve of the rotary slide valve being associated with each assembly position of the rotary slide.

3. The rotary slide valve according to claim 2, wherein the typical characteristic curves are different in each assembly position of the rotary slide.

4. The rotary slide valve according to claim 2, wherein the assembly positions differ in the height of the control gaps.

5. The rotary slide valve according to claim 2, wherein the assembly positions differ in the length of the control gaps.
